(19) United States
(12) Patent Application Publication
(10) Pub. No.: US 2018/0211120 A1
(43) Pub. Date: Jul. 26, 2018

(54) Training An Automatic Traffic Light Detection Model Using Simulated Images

(71) Applicant: Ford Global Technologies, LLC, Dearborn, MI (US)

(72) Inventors: Simon Murtha Smith, San Francisco, CA (US); Ashley Elizabeth Micks, Mountain View, CA (US); Maryam Moosaei, Mishawaka, IN (US); Vidya Nariyambut Murali, Sunnyvale, CA (US); Madeline J. Goh, Palo Alto, CA (US)

(21) Appl. No.: 15/415,718

(22) Filed: Jan. 25, 2017

(51) Int. Cl. G06K 9/00; G06N 99/00; G05D 1/00; G06K 9/66

(52) U.S. Cl. CPC G06K 9/00825; G06K 9/66; G05D 1/0088; G06N 99/005

(57) ABSTRACT

A scenario is defined that including models of vehicles and a typical driving environment as well as a traffic light having a state (red, green, amber). A model of a subject vehicle is added to the scenario and camera location is defined on the subject vehicle. Perception of the scenario by a camera is simulated to obtain an image. The image is annotated with a location and state of the traffic light. Various annotated images may be generated for difference scenarios, including scenarios lacking a traffic light or having traffic lights that do not govern the subject vehicle. A machine learning model is then trained using the annotated images to identify the location and state of traffic lights that govern the subject vehicle.

### BACKGROUND

### Field of the Invention

This invention relates to implementing control logic for an autonomous vehicle.

### Background of the Invention

Autonomous vehicles are becoming much more relevant and utilized on a day-to-day basis. In an autonomous vehicle, a controller relies on sensors to detect surrounding obstacles and road surfaces. The controller implements logic that enables the control of steering, braking, and accelerating to reach a destination and avoid collisions. In order to properly operate autonomously, the controller needs to identify traffic lights and determine the state thereof in order to avoid collisions with cross traffic.

The system and method disclosed herein provide an improved approach for performing traffic light detection in an autonomous vehicle.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIGS. 1A and 1B are schematic block diagrams of a system for implementing embodiments of the invention;

FIG. 2 is a schematic block diagram of an example computing device suitable for implementing methods in accordance with embodiments of the invention;

FIG. 3 is a method for generating annotated images from a 3D model for training a traffic light detection model in accordance with an embodiment of the present invention;

FIG. 4 illustrates a scenario for training a machine-learning model in accordance with an embodiment of the present invention; and

FIG. 5 is a process flow diagram of a method for training a model using annotated images in accordance with an embodiment of the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

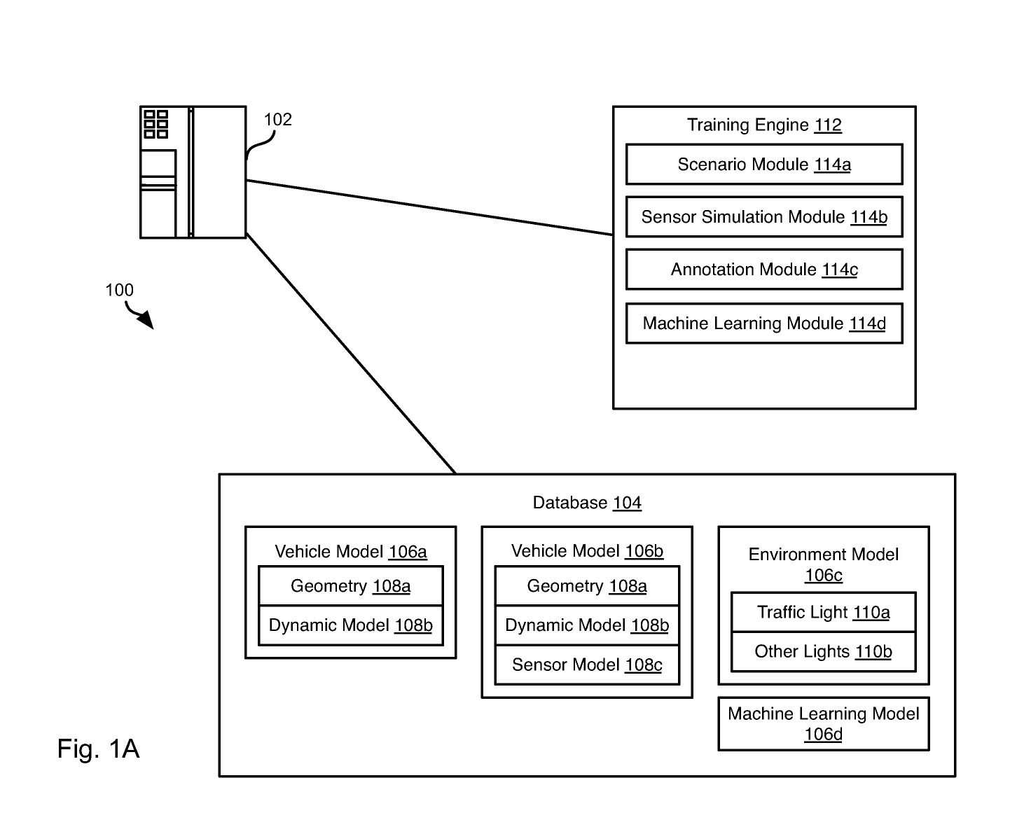

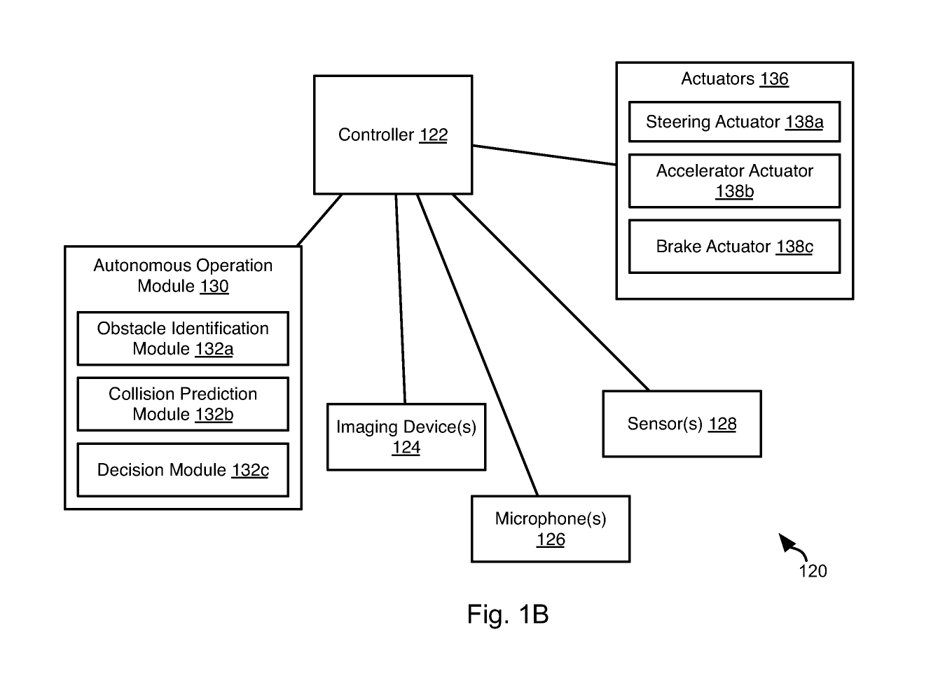

Referring to FIG. 1A, a network environment 100 may include a server system 102 that hosts or accesses a database 104 including data sufficient to define a scenario for training or evaluation of a detection system. In particular, the database 104 may store vehicle models 106a that include geometry data 108a for the vehicle, e.g. the shape of the body, tires, and any other visible features of the vehicle. The geometry data 108a may further include material data, such as hardness, reflectivity, or material type. The vehicle model 106a may further include a dynamic model 108b that indicates operation limits of the vehicle, e.g. turning radius, acceleration profile (maximum acceleration at a particular speed), and the like. The vehicle models 106a may be based on actual vehicles and the fields 108a,108b may be populated using data obtained from measuring the actual vehicles.

In some embodiments, the database 104 may store a vehicle model 106b for a vehicle incorporating one or more sensors that are used for obstacle detection. As described below, the outputs of these sensors may be input to a model that is trained or evaluated according to the methods disclosed herein. Accordingly, the vehicle model 106b may additionally include one or more sensor models 108c that indicate the locations of one or more sensors on the vehicle, the orientations of the one or more sensors, and one or more descriptors of the one or more sensors. For a camera, the sensor model 108c may include the field of view, resolution, zoom, frame rate, or other operational limit of the camera. For example, for a microphone, the sensor model 108c may include the gain, signal to noise ratio, sensitivity profile (sensitivity vs. frequency), and the like. For an ultrasonic, LIDAR (light detection and ranging), RADAR (radio detection and ranging), or SONAR (sound navigation and ranging) sensor, the sensor model 108c may include a resolution, field of view, and scan rate of the system.

The database 104 may include an environment model 106c that includes models of various landscapes, such models of city streets with intersections, buildings, pedestrians, trees etc. The models may define the geometry and location of objects in a landscape and may further include other aspects such as reflectivity to laser, RADAR, sound, light, etc. in order to enable simulation of perception of the objects by a sensor.

As described below, the methods disclosed herein are particularly suited for traffic light detection. Accordingly, the environment model 106c may include models of light sources such as traffic lights 110a and other lights 110b such as street lights, lighted signs, natural light sources (sun, moon, stars), and the like. In some embodiments, vehicle models 106a, 106b may also include light sources, such as taillights, headlights, and the like.

The database 104 may store a machine learning model 106d. The machine learning model 106d may be trained using the models 106a-106c according to the methods described herein. The machine learning model 106d may be a deep neural network, Bayesian network, or other type of machine learning model.

The server system 102 may execute a training engine 112. The training engine 112 may include a scenario module 114a. The scenario module 114a may retrieve models 106a-106c and generate a scenario of models of vehicles placed on and/or moving along models of roads. The scenario module 114a may generate these scenarios manually or receive human inputs specifying initial locations of vehicles, velocities of vehicles, etc. In some embodiments, scenarios may be modeled based on video or other measurements of an actual location, e.g. observations of a location, movements of vehicles in the location, the location of other objects, etc.

In some embodiments, the scenario module 114a may read a file specifying locations and/or orientations for various models of a scenario and create a model of the scenario having models 106a-106c of the elements positioned as instructed in the file. In this manner, manually or automatically generated files may be used to define a wide range of scenarios from available models 106a-106c.

The training engine 112 may include a sensor simulation module 114b. In particular, for a scenario, and a vehicle model 106b included in the scenario including sensor model data 108c, a perception of the scenario by the sensors may be simulated by the sensor simulation module 114b as described in greater detail below.

In particular, various rendering schemes may be used to render an image of the scenario from the point of a view of a camera defined by the sensor model 108c. Rendering may include performing ray tracing or other approach for modeling light propagation from various light sources 110a, 110b in the environment model 106c and vehicle models 106a, 106b.

The training engine 112 may include an annotation module 114c. Simulated sensor outputs from the sensor simulation module 114b may be annotated with “ground truth” of the scenario indicating the actual locations of obstacles in the scenario. In the embodiments disclosed herein, the annotations may include the location and state (red, amber, green) of traffic lights in a scenario that govern the subject vehicle 106b, i.e. direct traffic in the lane and direction of traffic of the subject vehicle 106b.

The training engine 112 may include a machine learning module 114d. The machine learning module 114d may train the machine learning model 106d. For example, the machine learning model 106d may be trained to identify the location of and state of a traffic light by processing annotated images. The machine learning model 106d may be trained to identify the location and state of traffic lights as well as whether the traffic light applies to the subject vehicle. The machine learning module 114d may train the machine learning model 106d by inputting the images as an input and the annotations for the images as desired outputs.

Referring to FIG. 1B, the machine learning model 106d as generated using the system of FIG. 1A may be used to perform traffic light detection in the illustrated system 120 that may be incorporated into a vehicle, such as an autonomous or human-operated vehicle. For example, the system 120 may include controller 122 housed within a vehicle. The vehicle may include any vehicle known in the art. The vehicle may have all of the structures and features of any vehicle known in the art including, wheels, a drive train coupled to the wheels, an engine coupled to the drive train, a steering system, a braking system, and other systems known in the art to be included in a vehicle.

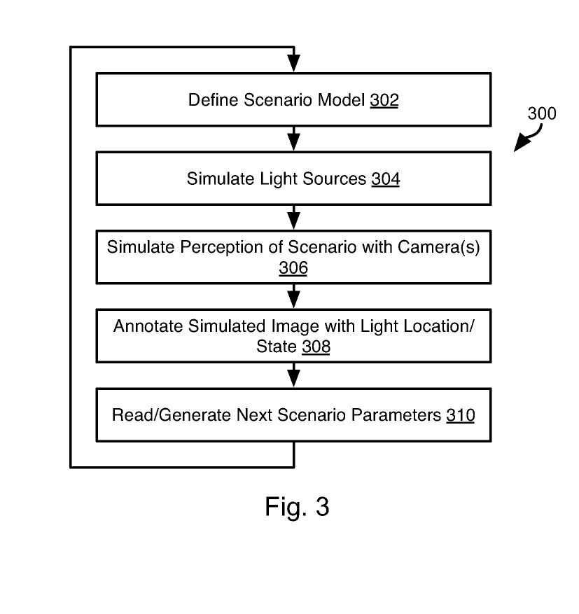

As discussed in greater detail herein, the controller 122 may perform autonomous navigation and collision avoidance using sensor data. Alternatively, the controller 122 may identify obstacles and generate user perceptible results using sensor data. In particular, the controller 122 may identify traffic lights in sensor data using the machine learning 106d trained as described below with respect to FIGS. 3 through 5.

The controller 122 may receive one or more image streams from one or more imaging devices 124. For example, one or more cameras may be mounted to the vehicle and output image streams received by the controller 122. The controller 122 may receive one or more audio streams from one or more microphones 126. For example, one or more microphones or microphone arrays may be mounted to the vehicle and output audio streams received by the controller 122. The microphones 126 may include directional microphones having a sensitivity that varies with angle.

In some embodiments, the system 120 may include other sensors 128 coupled to the controller 122, such as LIDAR (light detection and ranging), RADAR (radio detection and ranging), SONAR (sound navigation and ranging), ultrasonic sensor, and the like. The locations and orientations of the sensing devices 124, 126, 128 may correspond to those modeled in the sensor model 108c used to train the machine learning model 106d.

The controller 122 may execute an autonomous operation module 130 that receives outputs from some or all of the imaging devices 124, microphones 126, and other sensors 128. The autonomous operation module 130 then analyzes the outputs to identify potential obstacles

The autonomous operation module 130 may include an obstacle identification module 132a, a collision prediction module 132b, and a decision module 132c. The obstacle identification module 132a analyzes outputs of the sensing devices 124, 126, 128 and identifies potential obstacles, including people, animals, vehicles, buildings, curbs, and other objects and structures.

The collision prediction module 132b predicts which obstacle images are likely to collide with the vehicle based on its current trajectory or current intended path. The collision prediction module 132b may evaluate the likelihood of collision with objects identified by the obstacle identification module 132a as well as obstacles detected using the machine learning module 114d. The decision module 132c may make a decision to stop, accelerate, turn, etc. in order to avoid obstacles. The manner in which the collision prediction module 132b predicts potential collisions and the manner in which the decision module 132c takes action to avoid potential collisions may be according to any method or system known in the art of autonomous vehicles.

The decision module 132c may control the trajectory of the vehicle by actuating one or more actuators 136 controlling the direction and speed of the vehicle in order to proceed toward a destination and avoid obstacles. For example, the actuators 136 may include a steering actuator 138a, an accelerator actuator 138b, and a brake actuator 138c. The configuration of the actuators 138a-138c may be according to any implementation of such actuators known in the art of autonomous vehicles.

The decision module 132c may include or access the machine learning model 106d trained using the system 100 of FIG. 1A to process images from the imaging devices 124 in order to identify the location and states of traffic lights that govern the vehicle. Accordingly, the decision module 132c will stop in response to identifying a governing traffic light that is red and proceed if safe in response to identifying a governing traffic light that is green.

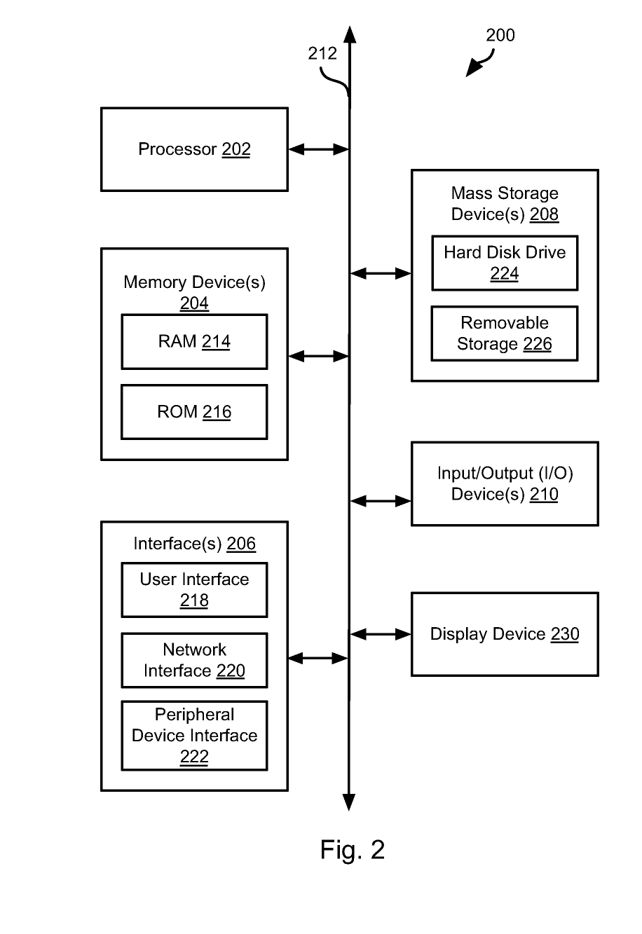

FIG. 2 is a block diagram illustrating an example computing device 200. Computing device 200 may be used to perform various procedures, such as those discussed herein. The server system 102 and controller 122 may have some or all of the attributes of the computing device 200.

Computing device 200 includes one or more processor(s) 202, one or more memory device(s) 204, one or more interface(s) 206, one or more mass storage device(s) 208, one or more Input/Output (I/O) device(s) 210, and a display device 230 all of which are coupled to a bus 212. Processor(s) 202 include one or more processors or controllers that execute instructions stored in memory device(s) 204 and/or mass storage device(s) 208. Processor(s) 202 may also include various types of computer-readable media, such as cache memory.

Memory device(s) 204 include various computer-readable media, such as volatile memory (e.g., random access memory (RAM) 214) and/or nonvolatile memory (e.g., read-only memory (ROM) 216). Memory device(s) 204 may also include rewritable ROM, such as Flash memory.

Mass storage device(s) 208 include various computer readable media, such as magnetic tapes, magnetic disks, optical disks, solid-state memory (e.g., Flash memory), and so forth. As shown in FIG. 2, a particular mass storage device is a hard disk drive 224. Various drives may also be included in mass storage device(s) 208 to enable reading from and/or writing to the various computer readable media. Mass storage device(s) 208 include removable media 226 and/or non-removable media.

I/O device(s) 210 include various devices that allow data and/or other information to be input to or retrieved from computing device 200. Example I/O device(s) 210 include cursor control devices, keyboards, keypads, microphones, monitors or other display devices, speakers, printers, network interface cards, modems, lenses, CCDs or other image capture devices, and the like.

Display device 230 includes any type of device capable of displaying information to one or more users of computing device 200. Examples of display device 230 include a monitor, display terminal, video projection device, and the like.

Interface(s) 206 include various interfaces that allow computing device 200 to interact with other systems, devices, or computing environments. Example interface(s) 206 include any number of different network interfaces 220, such as interfaces to local area networks (LANs), wide area networks (WANs), wireless networks, and the Internet. Other interface(s) include user interface 218 and peripheral device interface 222. The interface(s) 206 may also include one or more peripheral interfaces such as interfaces for printers, pointing devices (mice, track pad, etc.), keyboards, and the like.

Bus 212 allows processor(s) 202, memory device(s) 204, interface(s) 206, mass storage device(s) 208, I/O device(s) 210, and display device 230 to communicate with one another, as well as other devices or components coupled to bus 212. Bus 212 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 200, and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Referring to FIG. 3, the illustrated method 300 may be executed by the server system 102 in order to generate annotated images for training a machine learning model to identify governing traffic lights and the state thereof.

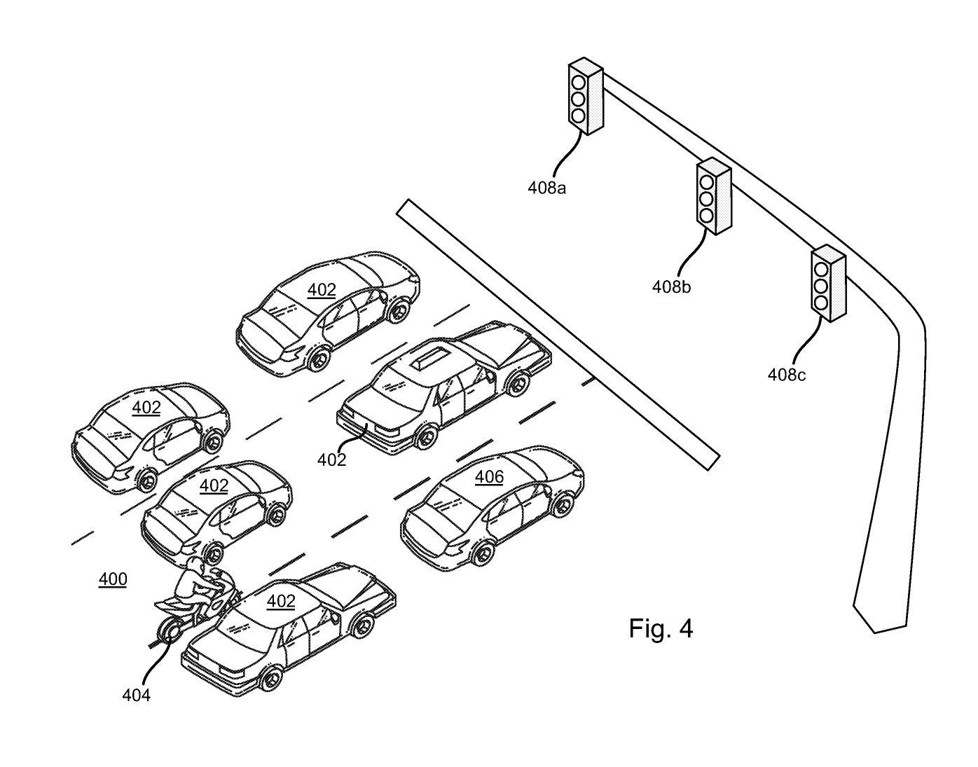

The method 300 may include defining 302 a scenario model. For example, as shown in FIG. 4, an environment model including a road 400 may be combined with models of vehicles 402, 404 placed within lanes of the road 400. Likewise, a subject vehicle 406 from whose point of view the scenario is perceived may also be included in the scenario model. The scenario model may be a static configuration or may be a dynamic model wherein vehicles 402, 404, 406 have velocities and accelerations that may vary from one time-step to the next during propagation of the scenario model.

The scenario model further includes one or more traffic lights 408a-408c. In one example, traffic light 408c governs subject vehicle 406, whereas traffic lights 408a-408b do not, e.g. traffic lights 408a-408b may be left turn lanes whereas traffic light 408c is not.

The scenario may include other light sources including headlights and taillights of any of the vehicles 402, 404, 406, traffic lights governing cross traffic, lighted signs, natural light (sun, moon stars), and the like.

In some embodiments, the machine learning model 106d is further trained to distinguish between images in which a traffic light is present and in which no traffic light is present. Accordingly, some scenarios may include no traffic light governing the subject vehicle 406 or include no traffic lights at all.

Referring again to FIG. 3, the method 300 may include simulating 304 propagation of light from the light sources of the scenario and perception of the scenario by one or more imaging devices 124 of the subject vehicle 406 may be simulated 306. In particular locations and orientations of imaging devices 124a-124d may be defined on the subject vehicle 406 in accordance with a sensor model 108c.

Steps 302 and 304 may include using any rendering technique known in the art of computer generated images. For example, the scenario may be defined using a gaming engine such as UNREAL ENGINE and a rendering of the scenario maybe generated using BLENDER, MAYA, 3D STUDIO MAX, or any other rendering software.

The output of steps 304, 306 is one or more images of the scenario model from the point of view of one or more simulated imaging devices. In some embodiments, where the scenario model is dynamic, the output of steps 304, 306 is a series of image sets, each image set including images of the scenario from the point of view of the image devices at a particular time step in a simulation of the dynamic scenario.

The method 300 may further include annotating 308 the images with the “ground truth” of the scenario model. Where the scenario model is dynamic, each image set may be annotated with the ground truth for the scenario model at the time step at which the images of the image set were captured.

The annotation of an image may indicate some or all of (a) whether a traffic light is present in the image, (b) the location of each traffic light present in the image, (c) the state of each traffic light present in the image, and (d) whether the traffic light governs the subject vehicle. In some embodiments, annotations only relate to a single traffic light that governs the subject vehicle, i.e. the location and state of the governing traffic light. Where no governing traffic light is present, annotations may be omitted for the image or may the annotation may indicate this fact.

The method 300 may be performed repeatedly to generate tens, hundreds, or even thousands of annotated images for training the machine learning model 106d. Accordingly, the method 300 may include reading 310 new scenario parameters from a file and defining 302 a new scenario model according to the new scenario parameters. Processing at step 304-308 may then continue. Alternatively, scenarios may be generated automatically, such as by randomly redistributing models of vehicles and light sources and modifying the location and or states of traffic lights.

For example, a library of models may be defined for various vehicles, buildings, traffic lights, light sources (signs, street lights, etc.). A file may therefore specify locations for various of these models and a subject vehicle. These models may then be placed in a scenario model at step 302 according to the locations specified in the file. The file may further specify dynamic parameters such as the velocity of vehicle models and the states of any traffic lights and dynamic changes in the states of traffic lights, e.g. transitions from red to green or vice versa in the dynamic scenario model. The file may further define other parameters of the scenario such as an amount of ambient natural light to simulate daytime, nighttime, and crepuscular conditions.

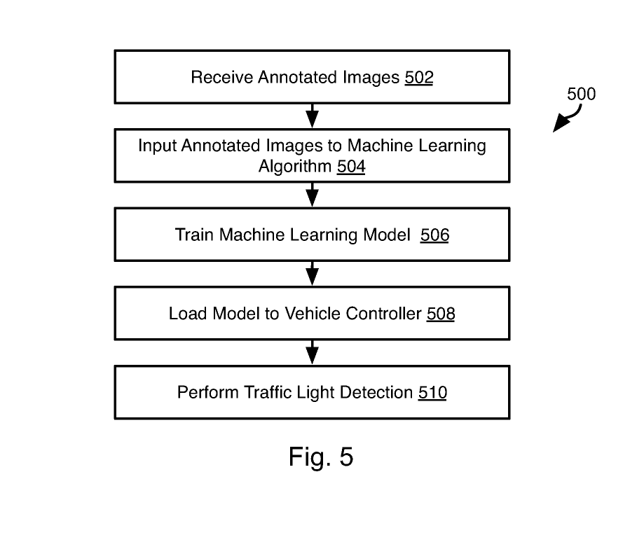

Referring to FIG. 5, the method 500 may be executed by the server system 102 in order to train the machine learning model 106d. The method 500 may include receiving 502 the annotated images and inputting 504 the annotated images to a machine learning algorithm.

In some embodiments, multiple imaging devices 124 are used to implement binocular vision. Accordingly, inputting annotated images may include processing a set of images for the same scenario or the same time step in a dynamic scenario to obtain a 3D point cloud, each point having a color (e.g., RGB tuple) associated therewith. This 3D point cloud may then be input to the machine learning model with the annotations for the images in the image set. Alternatively, the images may be input directly into the machine learning algorithm.

The machine learning algorithm may train 506 the machine learning model 106d according to the annotated images or point clouds. As noted above, tens, hundreds, or even thousands of image sets may be used at step 506 to train the machine learning model for a wide range of scenarios.

The method 500 may then include loading 508 the trained machine learning model 106d into a vehicle, such as the vehicle controller 122 of the system 120 shown in FIG. 1B. The controller 122 may then perform 510 traffic light detection according to the trained machine learning model 106d. This may include detecting a governing traffic light and taking appropriate action such as stopping for a governing red light and proceeding if safe for a governing green light.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

1. A method comprising, by a computer system:
simulating perception of a 3D model having a traffic light model as a light source to obtain an image;
annotating the image with a location and state of the traffic light model to obtain an annotated image; and
training a model according to the annotated image.

2. The method of claim 1, wherein the 3D model includes a plurality of other light sources.

3. The method of claim 1, wherein the state of the traffic light model is one of red, amber, and green.

4. The method of claim 1, wherein simulating perception of the 3D model comprises simulating perception of the 3D model having one or more components of the 3D model in motion to obtain a plurality of images including the image;
wherein annotating the image with the location and state of the traffic light model to obtain the annotated image comprises annotating the plurality of images with the state of the traffic light model to obtain a plurality of annotated images; and
wherein training the model according to the annotated image comprises training the model according to the plurality of annotated images.

5. The method of claim 1, wherein training the model according to the annotated image comprises training a machine learning algorithm according to the annotated image.

6. The method of claim 1, wherein training the model according to the annotated image comprises training the model to identify a state and location of an actual traffic light in a camera output.

7. The method of claim 1, wherein training the model according to the annotated image comprises training the model to output whether the traffic light applies to a vehicle processing camera outputs according to the model.

8. The method of claim 1, wherein the 3D model is a first 3D model, the image is a first image, and the annotated image is a first annotated image, the method further comprising:
reading a configuration file defining location of one or more components;
generating a second 3D model according to the configuration file;
simulating perception of the second 3D model to obtain a second image;
annotating the second image with a location and state of the traffic light in the second 3D model to obtain a second annotated image; and
training the model according to both of the first annotated image and the second annotated image.

9. The method of claim 1, wherein the 3D model is a first 3D model and the image is a first image, and the annotated image is a first annotated image, the method further comprising:
defining a second 3D model having a traffic light model that does not govern a subject vehicle model;
simulating perception of the second 3D model from a point of view of a camera of to the subject vehicle model to obtain a second image;
annotating the second image to that second 3D model includes no traffic light model governing the subject vehicle model; and
training the model according to both of the first annotated image and the second annotated image.

10. The method of claim 1, wherein the 3D model is a first 3D model and the image is a first image, and the annotated image is a first annotated image, the method further comprising:
defining a second 3D model having no traffic light model;
simulating perception of the second 3D model to obtain a second image;
annotating the second image to that second 3D model includes no traffic light model; and
training the model according to both of the first annotated image and the second annotated image.

11. A system comprising one or more processing devices and one or more memory devices operably coupled to the one or more processing devices, the one or more processing devices storing executable code effective to cause the one or more processing devices to:
simulate perception of a 3D model having a traffic light model as a light source to obtain an image;
annotate the image with a location and state of the traffic light model to obtain an annotated image; and
train a model according to the annotated image.

12. The system of claim 11, wherein the 3D model includes a plurality of other light sources.

13. The system of claim 11, wherein the state of the traffic light model is one of red, amber, and green.

14. The system of claim 11, wherein the executable code is further effective to cause the one or more processing devices to:
simulate perception of the 3D model by simulating perception of the 3D model having one or more components of the 3D model in motion to obtain a plurality of images including the image;
annotate the image with the location and state of the traffic light model to obtain the annotated image by annotating the plurality of images with the state of the traffic light model to obtain a plurality of annotated images; and
train the model according to the annotated image by training the model according to the plurality of annotated images.

15. The system of claim 11, wherein the executable code is further effective to cause the one or more processing devices to train the model according to the annotated image by training a machine learning algorithm according to the annotated image.

16. The system of claim 11, wherein the executable code is further effective to cause the one or more processing devices to train the model according to the annotated image by training the model to identify a state and location of an actual traffic light in a camera output.

17. The system of claim 11, wherein the executable code is further effective to cause the one or more processing devices to train the model according to the annotated image by training the model to output whether the traffic light applies to a vehicle processing camera outputs according to the model.

18. The system of claim 11, wherein the 3D model is a first 3D model, the image is a first image, and the annotated image is a first annotated image;
wherein the executable code is further effective to cause the one or more processing devices to:
read a configuration file defining location of one or more components;
generate a second 3D model according to the configuration file;
simulate perception of the second 3D model to obtain a second image;
annotate the second image with a location and state of the traffic light in the second 3D model to obtain a second annotated image; and
train the model according to both of the first annotated image and the second annotated image.

19. The system of claim 11, wherein the 3D model is a first 3D model and the image is a first image, and the annotated image is a first annotated image, the method further comprising:
wherein the executable code is further effective to cause the one or more processing devices to:
define a second 3D model having a traffic light model that does not govern a subject vehicle model;
simulate perception of the second 3D model from a point of view of one or more cameras of the subject vehicle model to obtain a second image;
annotate the second image to that second 3D model includes no traffic light model governing the subject vehicle model; and
train the model according to both of the first annotated image and the second annotated image.

20. The system of claim 11, wherein the 3D model is a first 3D model and the image is a first image, and the annotated image is a first annotated image, the method further comprising:
wherein the executable code is further effective to cause the one or more processing devices to:
define a second 3D model having no traffic light model;
simulate perception of the second 3D model to obtain a second image;
annotate the second image to that second 3D model includes no traffic light model; and
train the model according to both of the first annotated image and the second annotated image.
